(19) United States
(12) Patent Application Publication
(10) Pub. No.: US 2003/0062136 A1
(43) Pub. Date: Apr. 3, 2003

(54) Curtain and blind arrangement

(75) Inventor: Ming Nien, Changhua Hsien (TW)

Correspondence Address: BROWDY AND NEIMARK, P.L.L.C., 624 NINTH STREET, NW, SUITE 300, WASHINGTON, DC, 20001-5303, US

(73) Assignee: Nien Made Enterprise Co., Ltd., Fang Yuan Hsian Chang Hua Hsien (TW)

(21) Appl. No.: 09/964,486

(22) Filed: Sep. 28, 2001

(51) Int. Cl. E06B 3/48

(52) U.S. Cl. 160/84.04

(57) ABSTRACT

A curtain and blind arrangement includes a blind, the blind having a plurality of slats, and a curtain, the curtain having a curtain body and a plurality of sleeves disposed at one side of the curtain body corresponding to the slats and adapted to secure the curtain body to the blind, the sleeves each defining a receiving hole adapted to receive the slats respectively.

### BACKGROUND OF THE INVENTION

The present invention relates to curtains and blinds and, more particularly, to a curtain and blind arrangement, which enables the curtain to be conveniently detachably fastened to the blind.

In order to improve light shading effect or to improve the sense of beauty, various Venetian blinds with an attached curtain have been disclosed. U.S. Pat. No. 5,743,318 provides a similar design. According to U.S. Pat. No. 5,743,318, each slat of the blind has a guide side, a back end side, a front guide formed on the guide side and defining a receiving chamber; the curtain has a first lateral side, a second lateral side, and a plurality of coupling elements arranged in parallel on the curtain subject to a predetermined pitch and respectively inserted in the receiving chamber of each of the slats to suspend the curtain from the blind over the guide side of the slats. Because this design requires complicated coupling members to join the curtain and the blind, the manufacturing procedure is complicated and, the manufacturing cost is greatly increased. Further, because the installation requires techniques, only well-trained persons can do the job, i.e., the consumers must hire a professional person to install the curtain in the blind.

### SUMMARY OF THE INVENTION

The present invention has been accomplished to provide a curtain and blind arrangement, which eliminates the aforesaid problems. It is the main object of the present invention to provide a curtain and blind arrangement, which enables the curtain to be detachably fastened to the blind without the use of any external coupling means. To achieve this and other objects of the present invention, the curtain and blind arrangement includes a blind having a plurality of slats, and a curtain having a curtain body and a plurality of sleeves disposed at one side of the curtain body corresponding to the slats and adapted to secure the curtain body to the blind, the sleeves each defining a receiving hole adapted to receive the slats respectively.

### BRIEF DESCRIPTION OF THE DRAWINGS

FIG. 1 is an exploded view of a curtain and blind arrangement according to a first embodiment of the present invention.

FIG. 2 is an assembly view of the curtain and blind arrangement of the first embodiment of the present invention.

FIG. 3 is a schematic drawing showing the formation of the sleeves on the curtain body according to the first embodiment of the present invention.

FIG. 4 is an exploded view of a curtain and blind arrangement according to a second embodiment of the present invention.

FIG. 5 is an exploded view of a curtain and blind arrangement according to a third embodiment of the present invention.

FIG. 6 is an exploded view of a curtain and blind arrangement according to a fourth embodiment of the present invention.

FIG. 7 is an exploded view of a curtain and blind arrangement according to a fifth embodiment of the present invention.

FIG. 8 is a perspective view of a curtain and blind arrangement according to a sixth embodiment of the present invention.

### DETAILED DESCRIPTION OF THE PREFERRED EMBODIMENT

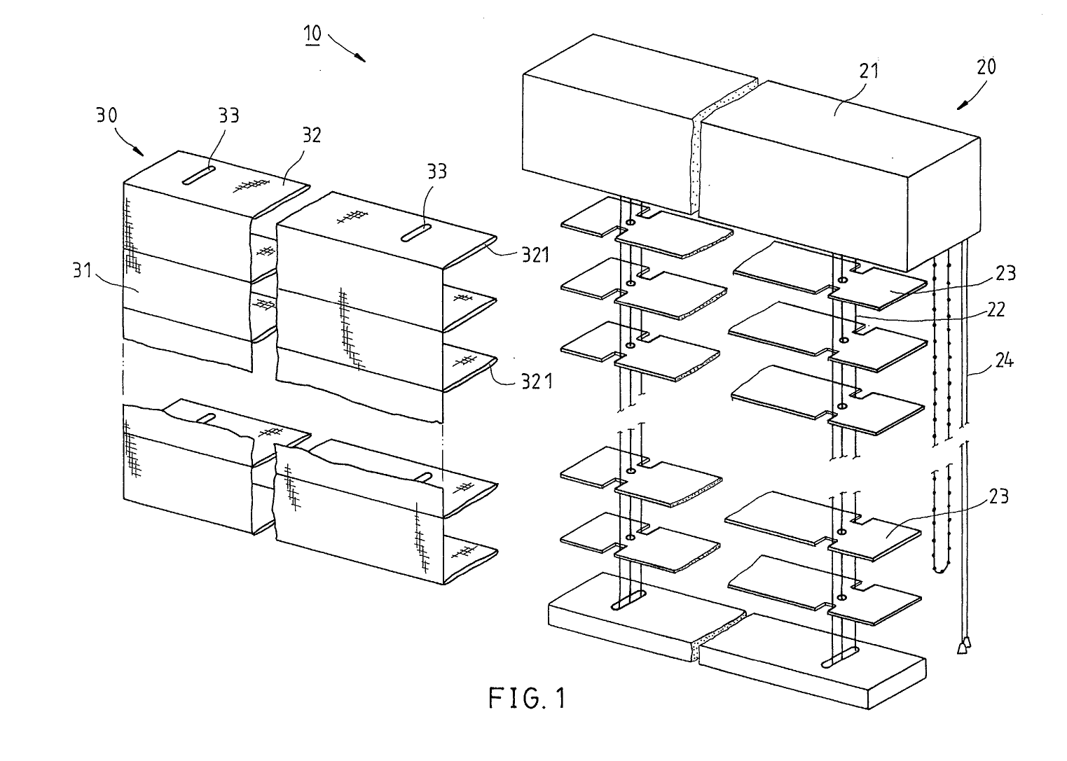

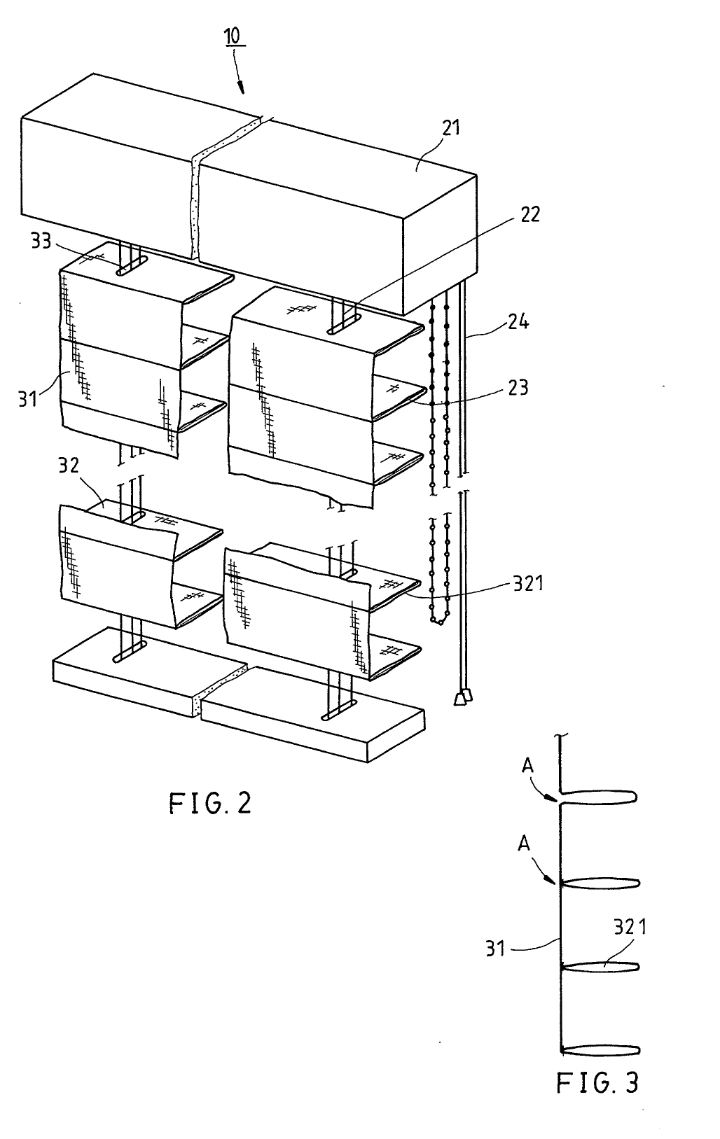

Referring to FIGS. 1 and 2, the curtain and blind arrangement 10 according to a first embodiment of the present invention is shown comprised of a Venetian blind 20, and a curtain 30.

The Venetian blind 20 comprises a head box 21, two connecting sets 22, a plurality of slats 23, and a tilt cord 24. The head box 21 is fixedly fastened to the wall above the window. The braided ladders 22 are flexible cord members bilaterally suspended from the head box 21. The slats 23 are fastened to the braided ladders 22 at different elevations at equal pitch and arranged in parallel. The tilt cord 24 is installed in the head box 21 and linked to the braided ladders 22 for turning by hand to tilt the slats 23 so as to regulate the light.

The curtain 30 is a woven material of natural yarn (silk, wool, cotton) or synthetic yarn (nylon, Tetoron, etc.), comprising a curtain body 31, a plurality of sleeves 32, and a plurality of insertion slots 33. The curtain body 31 is adapted to increase light shading effect and to make the Venetian blind more beautiful. The covering area of the curtain body 31 is not less than the total covering area of the slats 23 when the slats 23 are closed to block the light. The sleeves 32 are respectively formed of a part of the curtain body 31, i.e., the curtain body 31 is curved at a predetermined pitch (see mark A in FIG. 3) and then stitched to form a respective sleeve 32. Each sleeve 32 defines a receiving hole 321 adapted to receive one slat 23. The diameter of the receiving hole 321 fits the cross section of the slats 23. The sleeves 32 are transversely disposed at the backside of the curtain body 31 corresponding to the slats 23. The insertion slots 33 respectively extended through the sleeves 32 for the passing of the braided ladders 22

During installation, the sleeves 32 are respectively sleeved onto the slats 23, enabling the braided ladders 22 to pass through the insertion slots 33. After installation of the braided ladders 22, the curtain 30 is coupled to the slats 23 of the Venetian blind 20.

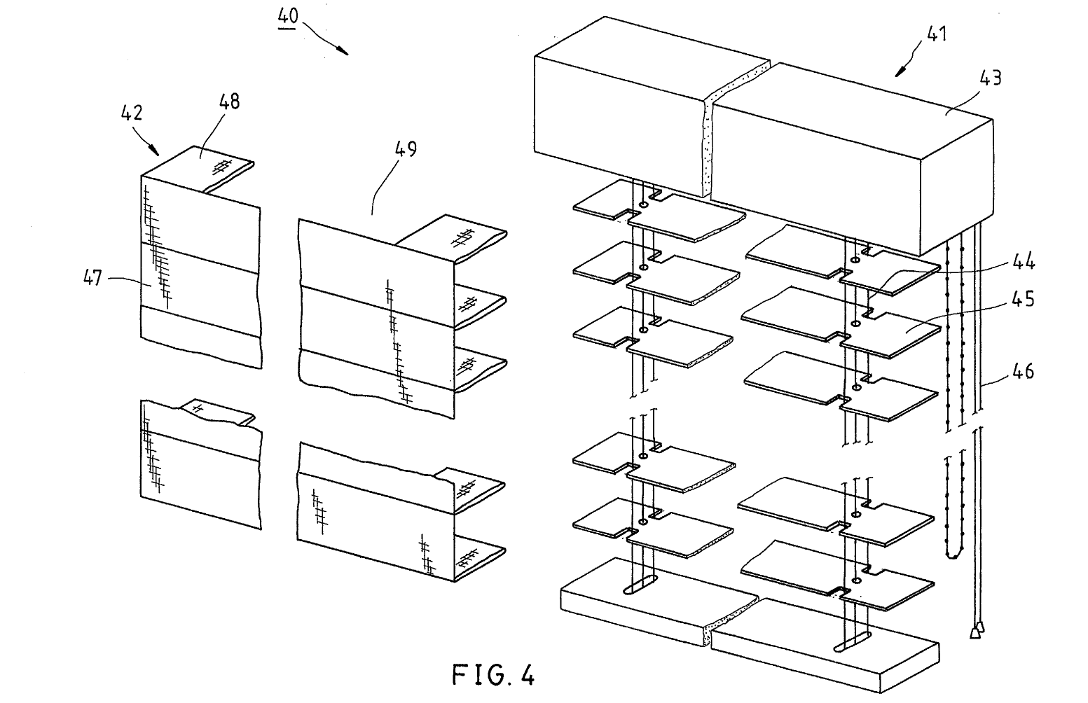

FIG. 4 shows a second embodiment of the preset invention. According to this embodiment, the curtain and blind arrangement 40 is comprised of a Venetian blind 41, and a curtain 42.

The Venetian blind 41 comprises a head box 43, two braided ladders 44, a plurality of slats 45, and a tilt cord 46. The curtain 42 is comprised of a curtain body 47 and a plurality of sleeves 48. According to this embodiment, the sleeves 48 are arranged on the backside of the curtain body 47 in two vertical rows spaced by a space 49. During installation, the two rows of sleeves 48 are respectively sleeved onto two distal ends of each of the slats 45. Because the two rows of sleeves 48 are spaced by the space 49, the braided ladders 44 do not hinder the insertion of the slats 45 into the sleeves 48.

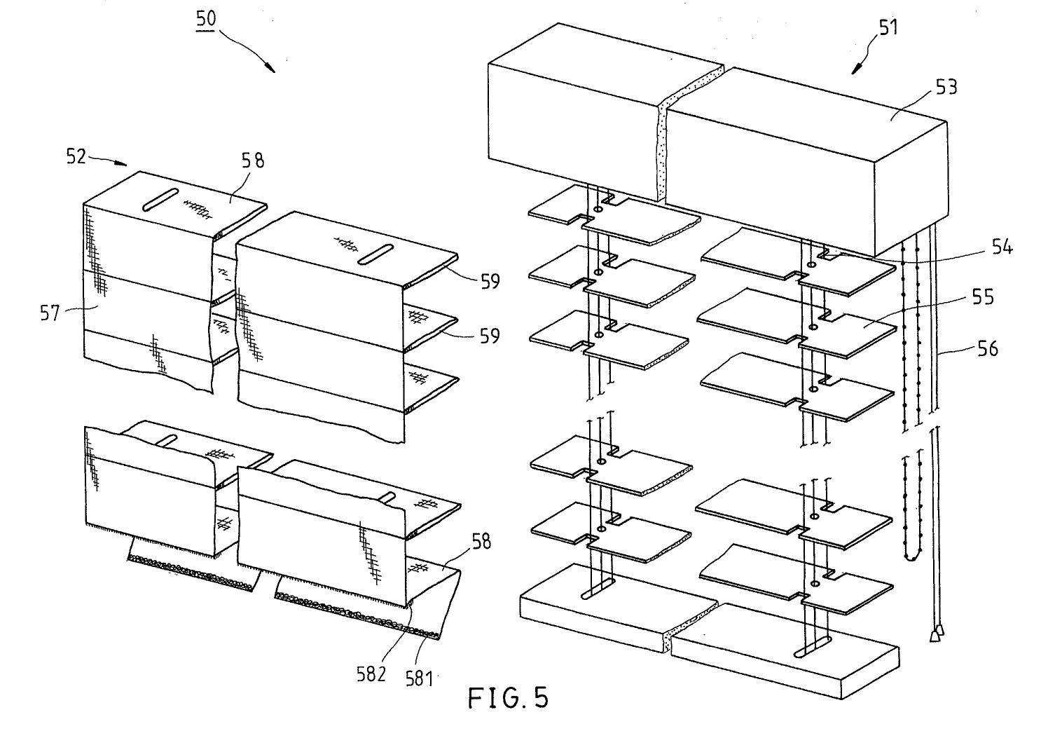

FIG. 5 shows a third embodiment of the preset invention. According to this embodiment, the curtain and blind arrangement 50 is comprised of a Venetian blind 51, and a curtain 52.

The Venetian blind 51 comprises a head box 53, two braided ladders 54, a plurality of slats 55, and a tilt cord 56. The curtain 52 is comprised of a curtain body 57 and a plurality of sleeves 58. According to this embodiment, the sleeves 58 are respectively formed of a flexible shectlike member having a fixed end 582 and a free end 581 detachably fastened to the fixed end 582 by means of Velcro to form a receiving hole 59 adapted to receive one slat 55.

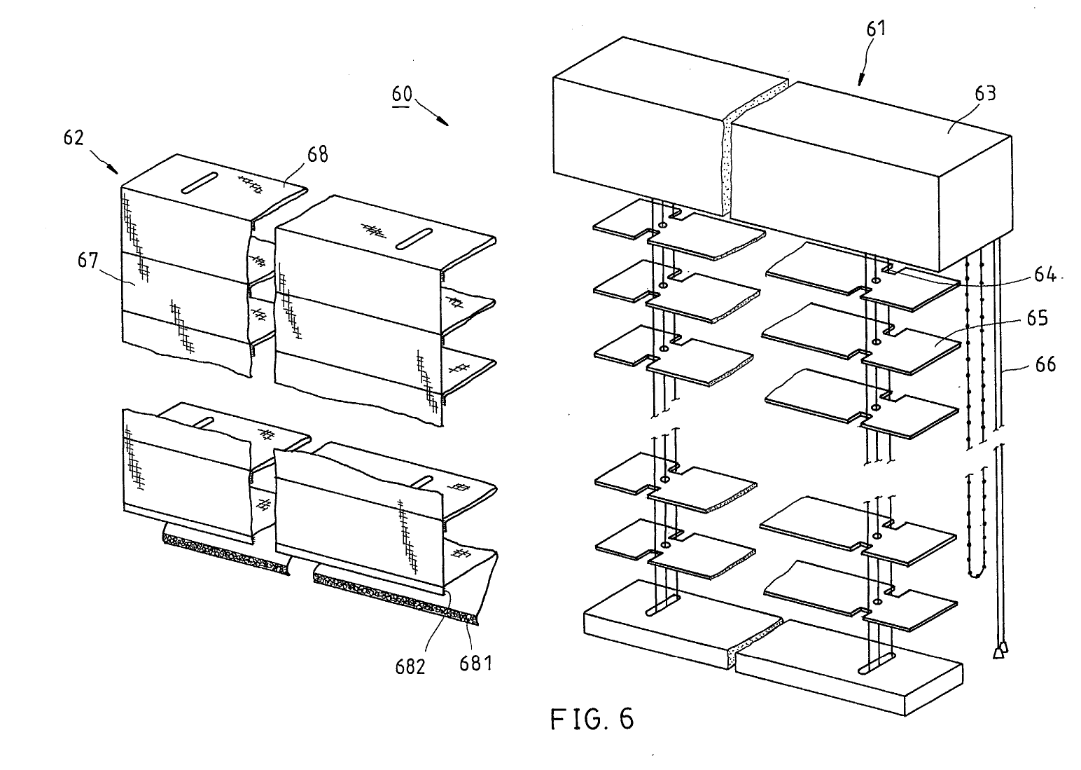

FIG. 6 shows a fourth embodiment of the preset invention. According to this embodiment, the curtain and blind arrangement 60 is comprised of a Venetian blind 61, and a curtain 62.

The Venetian blind 61 comprises a head box 63, two braided ladders 64, a plurality of slats 65, and a tilt cord 66. The curtain 62 is comprised of a curtain body 67 and a plurality of sleeves 68. According to this embodiment, the sleeves 68 are respectively formed of a flexible sheetlike member having a fixed end 682 fixedly fastened to the curtain body 67 and a free end 681 detachably fastened to the curtain body 67 adjacent to the fixed end 682 by fastening means, for example, hook and loop materials.

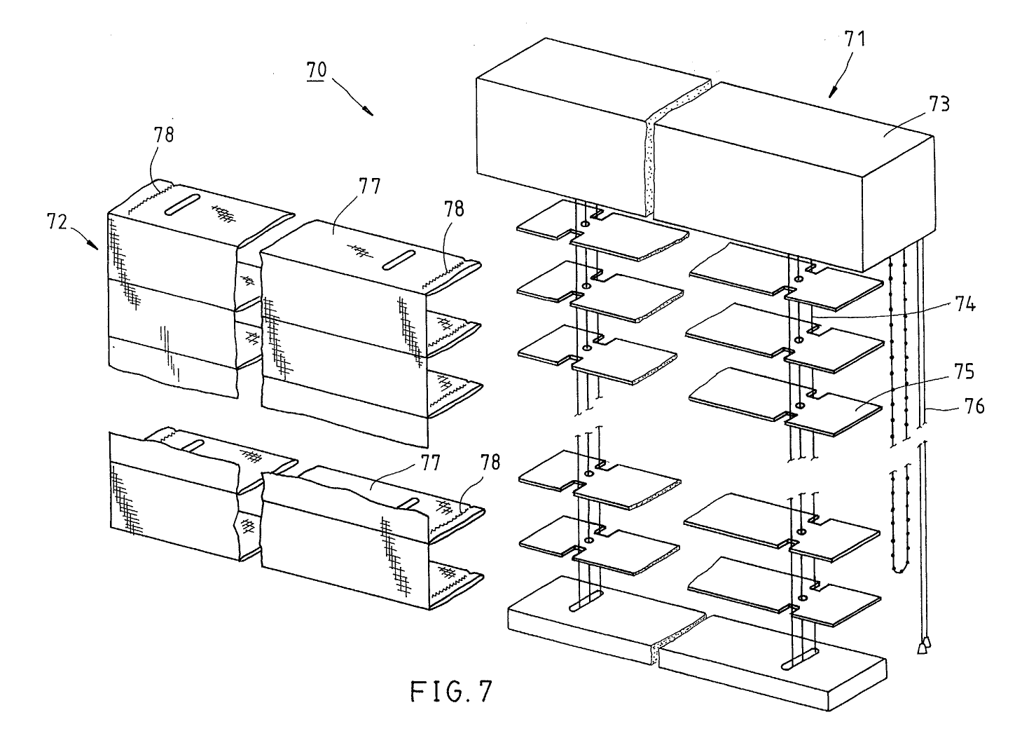

FIG. 7 shows a fifth embodiment of the preset invention. According to this embodiment, the Venetian blind and curtain arrangement 70 is comprised of a Venetian blind 71, and a curtain 72.

The Venetian blind 71 comprises a head box 73, two braided ladders 74, a plurality of slats 75, and a tilt cord 76. The curtain 72 comprises a plurality of sleeves 78, and a plurality of elastic binding members, for example, elastic bands 78 respectively installed at the two ends of each sleeve 77 and adapted to secure the sleeves 77 to the slats 75 positively.

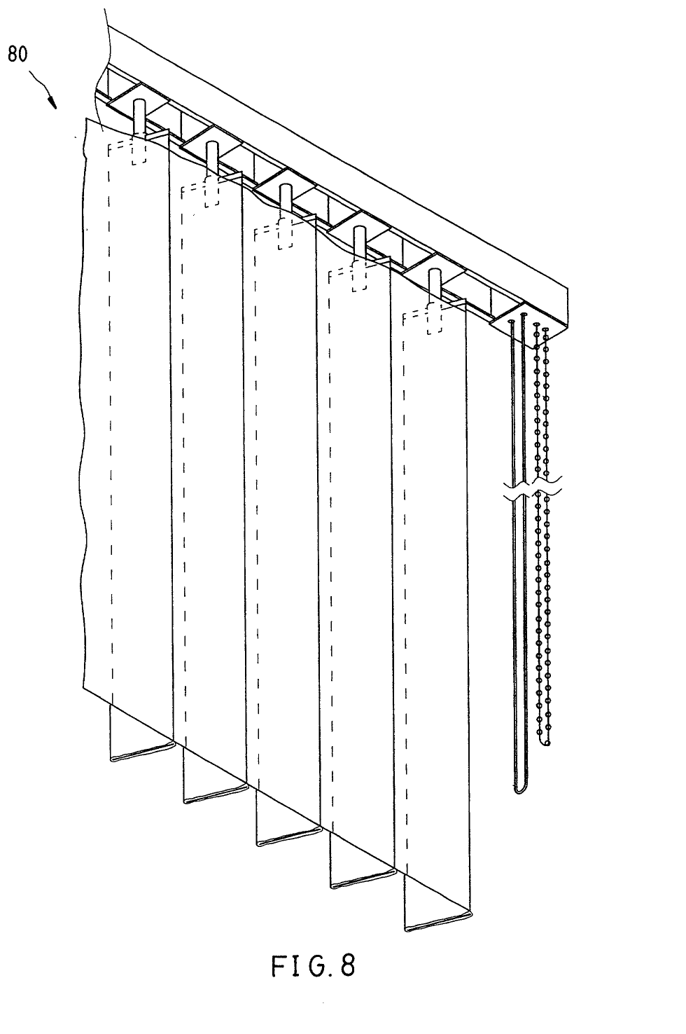

According to the aforesaid embodiments of the present invention, the slats of the Venetian blind are disposed in horizontal, and the sleeves are transversely arranged on the backside of the curtain body of the curtain for coupling to the slats of the Venetian blind. This coupling structure can also be employed to a vertical blind. FIG. 8 shows the curtain coupled to the vertical slats of a vertical blind 80 according to the present invention. Further, the sleeves of the curtain can also be directly made of elastic binding members, for example, elastic bands.

As indicated above, the invention achieves the following advantages:

1. Because the curtain is installed in the blind simply by putting the sleeves of the curtain on the slats of the blind without the use of any external fastening means, the installation of the curtain is easy, and the manufacturing of the blind and the curtain is simple and inexpensive.

2. The curtain greatly improves the light shading effect of the blind and causes a sense of beauty. Because the curtain is detachable, the consumer can conveniently replace the curtain with a different design when required

A prototype of curtain and blind arrangement has been constructed with the features of FIGS. 1˜8. The curtain and blind arrangement functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A curtain and blind arrangement comprising;
a blind, said blind comprising a plurality of slats; and
a curtain, said curtain comprising a curtain body and a plurality of sleeves equally spaced at one side of said curtain body corresponding to said slats and adapted to secure said curtain body to said blind, said sleeves each defining a receiving hole adapted to receive said slats respectively.

2. The curtain and blind arrangement of claim 1 wherein said sleeves are formed of a part of said curtain body.

3. The curtain and blind arrangement of claim 2 wherein said curtain body is curved and stitches subject to a predetermined pitch to form said sleeves.

4. The curtain and blind arrangement of claim 1 wherein said sleeves extending transversely at one side of said curtain body.

5. The curtain and blind arrangement of claim 1 wherein said sleeves are arranged at one side of said curtain body in two vertical rows.

6. The curtain and blind arrangement of claim 1 wherein said sleeves each are formed of a flexible sheet member, said flexible sheet member having a fixed end fixedly fastened to said curtain body and a free end detachably fastened to said fixed end by fastening means.

7. The curtain and blind arrangement of claim 1 wherein said sleeves each are formed of a flexible sheet member, said flexible sheet member having a fixed end fixedly fastened to said curtain body and a free end detachably fastened to said curtain body adjacent to said fixed end by fastening means.

8. The curtain and blind arrangement of claim 1 wherein said curtain further comprises a plurality of binding members respectively installed at two ends of each sleeve and adapted to secure said sleeves to said slats.

9. The curtain and blind arrangement of claim 1 wherein said blind further comprising two connecting sets having a plurality of cord members for fastening said slats, and said sleeves of said curtain each have a plurality of insertion slots for the passing of said cord members.

10. The curtain and blind arrangement of claim 1 wherein said sleeves are respectively formed of elastic binders.
